(19) United States
(12) Patent Application Publication
(10) Pub. No.: US 2021/0089583 A1
(43) Pub. Date: Mar. 25, 2021

(54) OPTIMIZING THE DISTRIBUTION OF ASSETS

(71) Applicant: INTERNATIONAL BUSINESS MACHINES CORPORATION, Armonk, NY (US)

(72) Inventor: Lisa Seacat DeLuca, Baltimore, MD (US)

(21) Appl. No.: 16/582,048

(22) Filed: Sep. 25, 2019

(51) Int. Cl. G06F 16/9035; G06F 16/9038; G06F 17/15

(52) U.S. Cl. CPC G06F 16/9035; G06F 17/15; G06F 16/9038

(57) ABSTRACT

The exemplary embodiments disclose a system and method, a computer program product, and a computer system for optimizing the distribution of assets. The exemplary embodiments may include collecting data and extracting one or more factors from the collected data. The exemplary embodiments may additionally include distributing the one or more assets by applying one or more models to the extracted one or more factors.

### BACKGROUND

The exemplary embodiments relate generally to asset management, and more particularly to optimizing the distribution of assets.

Corporations may acquire various assets to run their business. Such assets may include equipment, such as computers, desks, chairs, printers, scanners, vehicles, ovens, stovetops, refrigerators, exercise equipment, etc., as well as access credentials to a service, such as a license to software, a database, or application. In practice, it may be impractical in terms of cost, necessity, uptime, etc. for a corporation to acquire as many assets as there are users of said assets, creating a shared asset workspace. While a corporation may acquire an amount of assets required to satisfy the needs of users a majority of the time, instances may occur where there are fewer available assets than a number of users requesting to use the assets. In such circumstances, it is necessary to determine whom and what is provided access to the assets.

### SUMMARY

The exemplary embodiments disclose a system and method, a computer program product, and a computer system for optimizing the distribution of assets. The exemplary embodiments may include collecting data and extracting one or more factors from the collected data. The exemplary embodiments may additionally include distributing the one or more assets by applying one or more models to the extracted one or more factors.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of an asset distribution system 100, in accordance with the exemplary embodiments.

FIG. 2 depicts an exemplary flowchart illustrating the operations of an asset distributor 134 of the asset distribution system 100 in optimizing the distribution of one or more assets, in accordance with the exemplary embodiments.

FIG. 3 depicts an exemplary block diagram depicting the hardware components of the asset distribution system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

Many people, corporations, organizations, etc. maintain less supply of an asset than the demand for said asset. In other words, they have a finite number of a particular asset that is smaller than the number of individuals who desire to use that particular asset. For example, a corporation may have one standing desk and two employees who wish to use a standing desk. Some employees may have personal health issues that make them more in need of a standing desk. Other employees may need specific assets to complete a task, while others may work longer hours than other employees and therefore may utilize a standing desk more frequently or for a greater duration than others. There are many factors in addition to those listed above to consider when determining how to best allocate or distribute assets. Accordingly, there is a critical need for a system to account for not only the factors, but also the significance of different factors in order to determine an optimal distribution of assets.

Exemplary embodiments are directed to a method, computer program product, and computer system that will optimize the distribution of assets. In embodiments, machine learning may be used to create models capable of determining which users are provided access to one or more assets, while feedback loops may improve upon such models. Moreover, data from sensors, the internet, social networks, and user profiles may be utilized. In embodiments, such assets may be those utilized by one or more employees or contractors of a business, such as computers available to employees within a company, vehicles provided to drivers of a delivery service, standing desks offered to contractors within an office workplace setting, etc. Additionally, such assets may relate to those utilized by one or more customers or patrons, such as fitness equipment utilized by one or more gym members, computers available to the public at a library, bicycles available for public rental in a city, etc. In embodiments, the assets may also include digital media, such as a license to utilize software or access a database. In general, it will be appreciated that embodiments described herein may relate to aiding in the optimization of any asset within any environment.

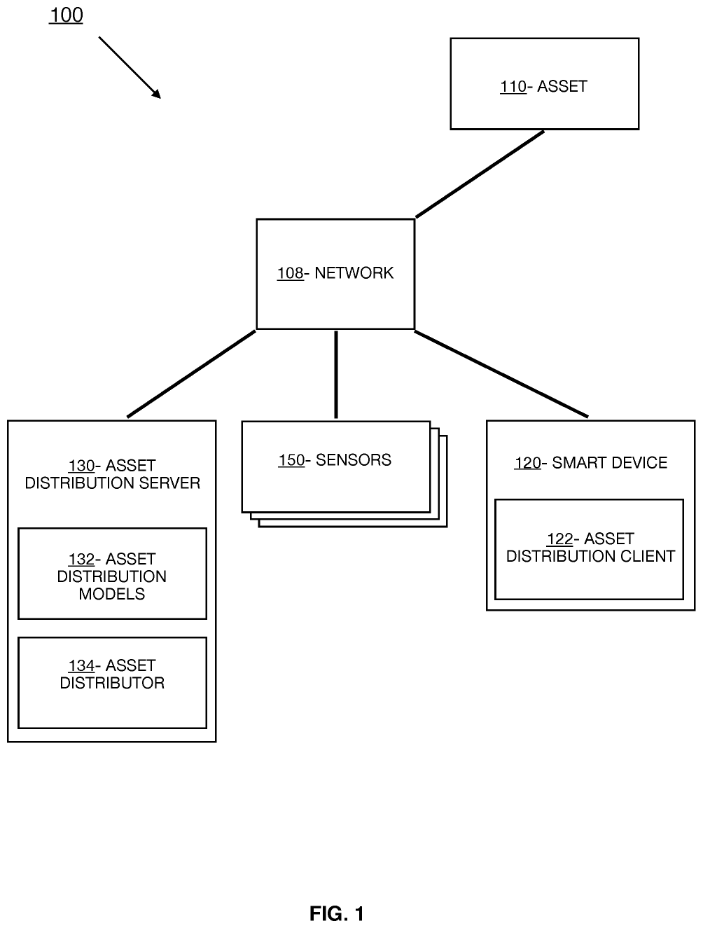

FIG. 1 depicts the asset distribution system 100, in accordance with the exemplary embodiments. According to the exemplary embodiments, the asset distribution system 100 may include an asset 110, a smart device 120, one or more sensors 150, and an asset distribution server 130, which may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the asset distribution system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a Wi-Fi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

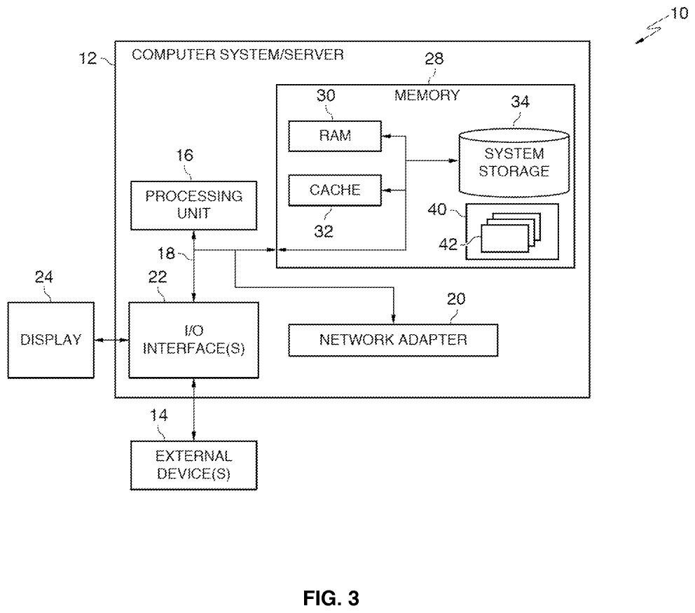

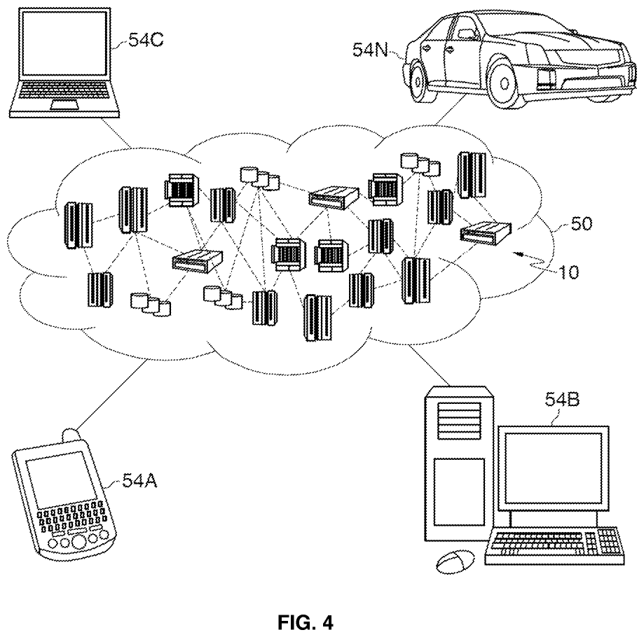

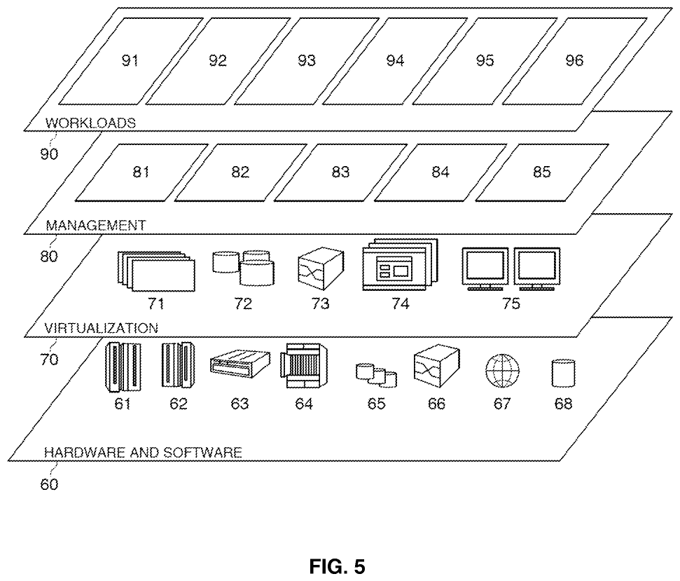

In the example embodiment, the asset 110 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of receiving and sending data to and from other computing devices. In addition, the asset 110 may be other equipment, such as desks, chairs, printers, scanners, vehicles, ovens, stovetops, refrigerators, exercise equipment, etc. In embodiments, the asset 110 may also be a digital/electronic asset or service, and comprise access to a file or access credentials to a license to software, database, or application. While the asset 110 is shown as a single device, in other embodiments, the asset 110 may be comprised of a cluster or plurality of computing devices, in a modular manner, etc., working together or working independently. The asset 110 is described in greater detail as a hardware implementation with reference to FIG. 3, as part of a cloud implementation with reference to FIG. 4, and/or as utilizing functional abstraction layers for processing with reference to FIG. 5.

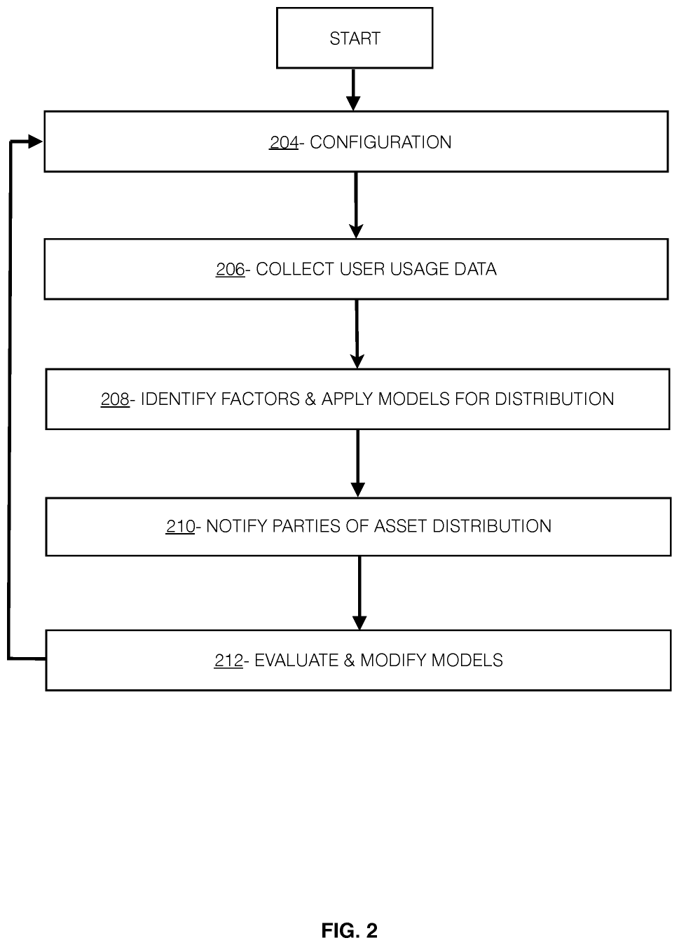

In the exemplary embodiments, the sensors 150 may be a camera, microphone, light sensor, infrared sensor, movement detection sensor, pressure sensor, thermometer, accelerometer, gyroscope, heart rate monitor, compass, barometer, or other sensory hardware/software equipment. In embodiments, the sensors 150 may be incorporated within an environment in which the asset distribution system 100 is implemented. For example, in embodiments, the sensors 150 may be security cameras incorporated into an office space and may communicate via the network 108. In other embodiments, the sensors 150 may be integrated with and communicate directly with smart devices such as the smart device 120 or the asset 110, e.g., smart phones and laptops. The sensors 150 are described in greater detail with respect to FIGS. 2-5.

In the example embodiment, the smart device 120 includes an asset distribution client 122, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of receiving and sending data to and from other computing devices. While the smart device 120 is shown as a single device, in other embodiments, the smart device 120 may be comprised of a cluster or plurality of computing devices, in a modular manner, etc., working together or working independently. The smart device 120 is described in greater detail as a hardware implementation with reference to FIG. 3, as part of a cloud implementation with reference to FIG. 4, and/or as utilizing functional abstraction layers for processing with reference to FIG. 5.

The asset distribution client 122 may be a software and/or hardware application capable of communicating with and providing a user interface for a user to interact with a server via the network 108. The asset distribution client 122 may act as a client in a client-server relationship. Moreover, in the example embodiment, the asset distribution client 122 may be capable of transferring data between the smart device 120 and other devices via the network 108. In embodiments, the asset distributor 134 utilizes various wired and wireless connection protocols for data transmission and exchange, including Bluetooth, 2.4 gHz and 5 gHz internet, near-field communication, Z-Wave, Zigbee, etc. The asset distribution client 122 is described in greater detail with respect to FIG. 2.

In the exemplary embodiments, the asset distribution server 130 includes one or more asset distribution models 132 and an asset distributor 134. The asset distribution server 130 may act as a server in a client-server relationship with the asset distribution client 122, and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the asset distribution server 130 is shown as a single device, in other embodiments, the asset distribution server 130 may be comprised of a cluster or plurality of computing devices, working together or working independently. The asset distribution server 130 is described in greater detail as a hardware implementation with reference to FIG. 3, as part of a cloud implementation with reference to FIG. 4, and/or as utilizing functional abstraction layers for processing with reference to FIG. 5.

The asset distribution models 132 may be one or more algorithms modelling a correlation between one or more factors and an optimal asset distribution. The one or more factors may include user data, usage data, etc., and may be detected via the one or more sensors 150 and the network 108. In embodiments, the asset distribution models 132 may weight the factors based on an effect that the one or more factors have on an optimal asset distribution. In the example embodiment, the asset distributor 134 may generate the asset distribution models 132 using machine learning methods, such as neural networks, deep learning, hierarchical learning, Gaussian Mixture modelling, Hidden Markov modelling, and K-Means, K-Medoids, or Fuzzy C-Means learning, etc. The asset distribution models 132 are described in greater detail with reference to FIG. 2.

The asset distributor 134 may be a software and/or hardware program capable of receiving a configuration of the asset distribution system 100. In addition, the asset distributor 134 may be further configured for collecting and processing user usage data. Moreover, the asset distributor 134 may be further configured for aggregating the processed data and applying one or more asset distribution models 132 to determine an optimized asset distribution. The asset distributor 134 is further capable of notifying parties of the optimized asset distribution. Lastly, the asset distributor 134 is capable of evaluating the optimized asset distribution, and adjusting its models based on the evaluation. The asset distributor 134 is described in greater detail with reference to FIG. 2.

FIG. 2 depicts an exemplary flowchart illustrating the operations of an asset distributor 134 of the asset distribution system 100 in determining an optimized asset distribution, in accordance with the exemplary embodiments.

The asset distributor 134 may receive a configuration (step 204). The asset distributor 134 may receive a configuration for the asset distribution system 100 that includes information such as administrative settings and user profiles. The administrative settings may be uploaded by an administrator, i.e., an individual with administrative authority with respect to the asset 110. For example, the administrator may be a human resources officer or office manager. In the example embodiment, the configuration may be received by the asset distributor 134 via the asset distribution client 122 and/or the network 108. Receiving administrative settings may involve receiving demographic information such as an administrator name, account credentials, company name, department, serial number, location, the one or more assets 110, types of the one or more assets 110, the one or more sensors 150 types, and the like. With respect to the one or more assets 110, the configuration may further include capabilities of the asset 110, such as capable functions/programs, processing power, capacities, range, etc. For example, the asset 110 may be a computing device having a processing power to perform video editing, a high-definition display suitable for photo editing, a word processor for preparing documents, or a connection to a color printer or scanner. Alternatively, the asset 110 may be fitness equipment that includes a higher maximum weight/speed, or a box truck with additional storage. In some embodiments, the asset 110 may be a digital license allowing for specific features or access to a particular database that other licenses may not provide. In addition to configuring the asset 110, the administrative registration may further include initializing and connecting to the one or more sensors 150. For example, the one or more sensors 150 may be incorporated into an environment implementing the asset distribution system 100, such as a security camera, pressure sensor, microphone, badge reader (RFID sensor), etc. In embodiments, the asset distributor 134 may utilize the sensors 150 in order to gather information about a user and usage of the asset 110 for later processing.

During configuration, the asset distributor 134 may further receive user profiles (step 204 continued). In embodiments, a user profile may include user data such as a name, gender, height, weight, age, fitness level, job title, seniority, etc. The data may further include information such as desired use of the asset 110 (e.g., needed functions/capabilities, capacities, processing speeds, licenses, data, etc.), asset exclusivity (e.g., are there other assets capable of performing this task), urgency of use, and any other data pertaining to potential usage of a given asset. In embodiments, the asset distributor 134 may prompt a user to populate a user profile via user input. The asset distributor 134 may additionally import, access, or view a user's profile from a database, such as a business directory, employee listing, government listing, etc. For example, the asset distributor 134 may populate user profiles based on a radio frequency identification (RFID) employee badge. User profiles may also include one or more preferences, such as a preferred method of notifying the users of the optimized asset distribution, such as via text message, email message, phone call, push notification, etc. In the event that the asset 110 display utilizes a user interface on its display, user profiles may also encompass any modifiable settings pertaining to the user interface. For example, the preferred information to be displayed on a user's asset 110 such as usage duration, percent usage, a countdown, etc. may be customizable within the user profiles.

To further illustrate the operations of the asset distributor 134, reference is now made to an illustrative example where the asset distributor 134 receives a configuration from an administrator at a corporate office indicating that the corporate office is equipped with one standing desk computer running the only video editing software application in the office. The asset distributor 134 further receives a user profile for a first user wishing to use the standing desk due to a health issue regarding weight management and due to a video-editing project due the following day. The asset distributor 134 also receives a user profile for a second user wishing to use the standing desk who is currently using crutches and currently working on a project due the following week that requires a word processing software available on sitting desk computers.

The asset distributor 134 may collect user usage data (step 206). The asset distributor 134 may be configured to collect usage data when, for example, data pertaining to a previous use of the asset 110 or other equipment is available. The usage data may include a usage frequency, an average usage duration, a distribution of usage times, an average degree of usage (actions per minute, emails sent per minute, etc.), an average downtime during usage (processing, loading, etc.), and any other data pertaining to the usage of an asset. In order to collect this data, the asset distributor 134 may collect data from the asset 110, the smart device 120, and/or the one or more sensors 150. For example, the asset distributor 134 may determine an average amount of time, frequency, degree of use, etc. regarding the asset 110 by reference to a calendar, schedule, work log, sign-up sheet, amount of time logged in, etc., indicative of use of the asset 110. Alternatively, the asset distributor 134 may determine an average amount of time that a user utilizes the asset 110 via reference to the sensors 150 or the smart device 120. For example, the asset distributor 134 may reference a laptop camera or a security camera within the environment to determine a frequency of use of the asset 110. Additionally, the asset distributor 134 may reference the asset 110 or other sensors 150 to determine a user's walking speed on a treadmill, number of phone calls made on a telephone, or number of times a standing desk is moved to or from the seated or standing position. Alternatively, the asset distributor 134 may reference one or more microphones in order to identify the sound of typing, speaking, music, etc., indicative of a degree of use of the asset 110. Moreover, the asset distributor 134 may reference one or more pressure sensors in the floor or seat to determine use of the asset 110. Overall, the asset distributor 134 may utilize any of the asset 110, the smart device 120, the sensors 150, and other components in determining user usage, and in some embodiments, user profile information. For example, the asset distributor 134 may further collect data from the asset 110 and the smart device 120 in order to determine information regarding the health of a user, ability, etc.

With reference again to the previously introduced example describing a standing desk within the corporate office, the asset distributor 134 collects data from the operating system of the standing desk to determine that the first user edits approximately three hours of video per hour while the second user edits approximately two hours of video per hour.

The asset distributor 134 may process the configuration data and usage data to identify factors and apply models (step 208). Such identified factors may include user ability, average duration of usage, average degree of usage, probability of usage, asset exclusivity, urgency of usage, and the like, which may contribute to determining an optimal asset distribution. With regard to user ability, the asset distributor 134 may process user and usage data to identify a user's user ability. User ability may pertain to a user's ability or preference to utilize an asset 110, and may take into account a user's health data or fitness data, for example that extracted from an electronic health record, workout schedule, workout device, etc. For example, the asset distributor 134 may process the collected or inputted data that a user has a broken leg to determine that the user has a low user ability for a standing desk. The asset distributor 134 may also process the collected or inputted data that a user weighs 150 pounds and is 40 years old to determine that the user is likely physically fit and has a high user ability for a standing desk. In addition to taking into account a user's health or fitness data, the asset distributor 134 may also take into account usage data pertaining to a user's physical ability, which may be collected by the asset 110, the smart device 120, and/or one or more sensors 150, such as video cameras, microphones, pressure sensors, accelerometers, gyroscopes, etc. For example, the asset distributor 134 may process video footage of a user using crutches to determine that the user has a low user ability for a standing desk. The asset distributor 134 may also process video footage of a user walking quickly to determine that the user has a high user ability for a standing desk.

In addition to processing data to identify a user's user ability, the asset distributor 134 may also process user and usage data to identify a user's average duration of usage (step 208 continued). Average duration of usage may pertain to the average number of hours worked per week by a user, the frequency of usage of an asset 110, and the like. For example, the asset distributor 134 may process badge reader, login, or security camera information to determine that a user works approximately 20 hours per week. In addition to taking into account a user's average number of hours worked per week or frequency of usage of an asset 110, the asset distributor 134 may also take into account usage data pertaining to a user's average duration of usage, which may be collected by the asset 110, the smart device 120, and/or the one or more sensors 150, such as video cameras, microphones, pressure sensors, and the like. For example, the asset distributor 134 may process operating system information to determine that the user works at the standing desk approximately 40 hours per week. Alternatively, pressure sensors may detect a user standing in front of their standing desk for 10 hours per week.

In addition to processing data to identify a user's average duration of usage, the asset distributor 134 may also process user and usage data to identify a user's average degree of usage (step 208 continued). Average degree of usage may pertain to the number of actions made by a user per minute, characters/words typed per minute, emails sent per minute, and the like. For example, the asset distributor 134 may process operating system data to determine that a user types an average of 45 words per minute. The asset distributor 134 may also process work log data to determine that a user output 15 emails in a day or sold 30 shipments of product in a day.

In addition to processing data to identify a user's average degree of usage, the asset distributor 134 may also process user and usage data to identify a user's probability of use, urgency of task, and/or asset exclusivity (step 208 continued). A user's probability of use, urgency of task, and asset exclusivity may be extracted from inputted and collected data such as job title, job description, seniority, and the like. For example, if a user's job pertains to graphic design, the asset distributor 134 may treat the user as having a higher probability of use for a high-resolution computer monitor than a user whose job pertains to running engineering calculations and experiments. With respect to asset urgency, the asset distributor 134 may reference a work log, schedule, user input, deadlines, etc. to determine an urgency of use of the asset 110. For example, the asset distributor 134 may determine that a first user's job requires that a calculation be run on a machine within the next 20 hours while a second user's job requires that a different calculation be run on the same machine within the next 48 hours, the asset distributor 134 may treat the first user as having a higher urgency of task for the asset 110 than the second user. The asset distributor 134 may further consider asset exclusivity. For example, the asset distributor 134 may determine that a first user's job pertains to engineering computations that can only be performed on a certain type of computer, and the asset distributor 134 may treat the first user as having a higher asset exclusivity value for a computer with those computational capabilities than a second user whose job functions may be completed on a wide variety of computer types.

In the example embodiment, the asset distributor 134 may apply the one or more asset distribution models 132 to the processed factors in order to determine an optimized asset distribution (step 208 continued). In embodiments, the asset distributor 134 determines an optimized asset distribution using one or more weights applied to the aforementioned features that are based on a training process performed prior to and/or concurrently with operation. Such a training process may be based on historic and labeled data and/or through use of a continuous feedback loop and may be used to determine a weight to apply to each of the aforementioned factors identified by the asset distributor 134 in determining the optimized asset distribution. Having established a weight to apply to each feature based on historic or current feedback, the asset distributor 134 is capable of applying the determined weights to new data of the foregoing factors, and thereby determining an optimized asset distribution consistent with historical or ideal considerations. In embodiments, the results of the asset distributor 134 may be values indicative of a priority to use the asset 110, for example a highest or lowest score. In other embodiments, the asset distributor 134 may be configured alternatively. In embodiments, the one or more asset distribution models 132 may be generated through machine learning techniques such as neural networks, hierarchical learning, or regularization.

With reference again to the previously introduced example with a standing desk at a corporate office, the asset distributor 134 processes data to determine that the first user should use the standing desk until the first user's project is complete, and then the second user should use the standing desk after the first user's project is completed.

The asset distributor 134 may notify parties of the optimized asset distribution (step 210). The asset distributor 134 may display its asset distribution decision on the asset 110 or other device, such as the smart device 120 (e.g., smart phone, smart tablet, augmented reality glasses, smart watch, etc.). For example, the asset distributor 134 may display a schedule indicating which of the assets 110 are provided to each user at different times throughout the hour/day/week/month/year. The display may incorporate the user's user interface settings and preferences, as discussed earlier. Notification of the optimized asset distribution may be in the form of a message to the users, administrator, and any others as dictated by inputted preferences in step 204. Notification may be via any message sending platform such as email, text message, or any social media platforms. The form or manner in which a notification or message is distributed may be customizable by the users, administrator, or by each individual receiving said notification or message. In embodiments in which the asset 110 is scheduled over the course of several hours/days/etc., the display may further include a timer or countdown until the asset 110 is provided to or revoked from the user. The asset distributor 134 may further receive user input from a user, for example requesting additional time with the asset 110, modifying user profile information, or other actions that may cause the asset distributor 134 to reevaluate the optimized asset distribution. Similar to requesting the use of the asset 110, requesting additional time and making changes to the user profile may be performed via the asset distribution client 122.

With reference again to the previously introduced example having a standing desk at a corporate office, the asset distributor 134 sends text messages to the smart phones of the administrator and the two users, stating its determination that the first user should use the standing desk until their project is complete, and then the second user should use the standing desk after the first user's project is completed. In embodiments, the asset distributor 134 may further populate this information on a schedule or calendar corresponding to the users or the asset 110.

The asset distributor 134 may evaluate and modify the asset distribution models 132 (step 212). In the example embodiment, the asset distributor 134 may verify whether the asset distribution decision was optimized properly in order to provide a feedback loop providing the capability to modify and tweak models and weighting values utilized in determining the asset distribution decision. In embodiments, the feedback loop may simply provide a means for an administrator to indicate whether they approve of the asset distribution decision. For example, the asset distributor 134 may prompt an administrator to select an option indicative of whether the asset distribution decision seemed blatantly incorrect. The option may comprise a toggle switch, button, slider, etc. that may be selected by the user manually by hand using a button/touchscreen/etc., by voice, by eye movement, and the like. If the administrator were to respond with “no,” the asset distributor 134 may modify its models to more heavily weight the factors used in making that asset distribution decision. Likewise, if the administrator were to respond with “yes,” the asset distributor 134 may modify its models to less heavily weight the factors used in making that asset distribution decision. In further embodiments, the asset distributor 134 may receive feedback via determining that an alternative distribution was implemented conversely to that recommended by the asset distributor 134. For example, if the asset distributor 134 determines that a user other than the suggested user utilizes an asset 110 via the sensors 150, the asset distributor 134 may adjust models accordingly.

With reference again to the previously introduced example with a standing desk at a corporate office, the asset distributor 134 prompts the administrator asking if the asset distribution decision seemed blatantly incorrect. The administrator responds to the prompt by pushing the “no” option. This feedback is used by the asset distributor 134 to modify its evaluation and weighting processes for future iterations.

FIG. 3 depicts a block diagram of devices within the asset distributor 134 of the asset distribution system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and asset distribution 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for optimizing the distribution of one or more assets, the method comprising:
collecting data selected from a group comprising asset data, user profile data, and user usage data;
extracting one or more factors from the collected data; and
distributing the one or more assets based on applying one or more models to the extracted one or more factors.

2. The method of claim 1, wherein the one or more models correlate the one or more factors with one or more users.

3. The method of claim 1, further comprising:
receiving feedback indicative of whether the one or more distributed assets are optimized; and
adjusting the model based on the received feedback.

4. The method of claim 1, wherein the user profile data includes data selected from a group comprising name, gender, height, weight, age, fitness level, job title, and seniority.

5. The method of claim 1, wherein the user usage data includes data selected from a group comprising sensor data, video data, audio data, pressure data, and operating system data.

6. The method of claim 1, wherein the one or more factors include factors selected from a group comprising user ability, average duration of usage, average degree of usage, probability of usage, asset exclusivity, and urgency of usage.

7. The method of claim 1, further comprising:
notifying one or more users of the distributed one or more assets.

8. A computer program product for identifying and emphasizing one or more objects of interest, the computer program product comprising:
one or more non-transitory computer-readable storage media and program instructions stored on the one or more non-transitory computer-readable storage media capable of performing a method, the method comprising:
collecting data selected from a group comprising asset data, user profile data, and user usage data;
extracting one or more factors from the collected data; and
distributing the one or more assets based on applying one or more models to the extracted one or more factors.

9. The computer program product of claim 8, wherein the one or more models correlate the one or more factors with one or more users.

10. The computer program product of claim 8, further comprising:
receiving feedback indicative of whether the one or more distributed assets are optimized; and
adjusting the model based on the received feedback.

11. The computer program product of claim 8, wherein the user profile data includes data selected from a group comprising name, gender, height, weight, age, fitness level, job title, and seniority.

12. The computer program product of claim 8, wherein the user usage data includes data selected from a group comprising sensor data, video data, audio data, pressure data, and operating system data.

13. The computer program product of claim 8, wherein the one or more factors include factors selected from a group comprising user ability, average duration of usage, average degree of usage, probability of usage, asset exclusivity, and urgency of usage.

14. The computer program product of claim 8, further comprising:
notifying one or more users of the distributed one or more assets.

15. A computer system for identifying and emphasizing one or more objects of interest, the computer system comprising:
one or more computer processors, one or more computer-readable storage media, and program instructions stored on the one or more of the computer-readable storage media for execution by at least one of the one or more processors capable of performing a method, the method comprising:
collecting data selected from a group comprising asset data, user profile data, and user usage data;
extracting one or more factors from the collected data; and
distributing the one or more assets based on applying one or more models to the extracted one or more factors.

16. The computer system of claim 15, wherein the one or more models correlate the one or more factors with one or more users.

17. The computer system of claim 15, further comprising:
receiving feedback indicative of whether the one or more distributed assets are optimized; and
adjusting the model based on the received feedback.

18. The computer system of claim 15, wherein the user profile data includes data selected from a group comprising name, gender, height, weight, age, fitness level, job title, and seniority.

19. The computer system of claim 15, wherein the user usage data includes data selected from a group comprising sensor data, video data, audio data, pressure data, and operating system data.

20. The computer system of claim 15, wherein the one or more factors include factors selected from a group comprising user ability, average duration of usage, average degree of usage, probability of usage, asset exclusivity, and urgency of usage.
